(19) United States
(12) Patent Application Publication
(10) Pub. No.: US 2020/0372876 A1
(43) Pub. Date: Nov. 26, 2020

(54) Display Emulation and Calibration

(71) Applicant: Apple Inc., Cupertino, CA (US)

(72) Inventors: Kevin W. Sliech, San Francisco, CA (US); Lu Zhang, Campbell, CA (US); Mingxia Gu, Campbell, CA (US); Robert L. Ridenour, Menlo Park, CA (US); Yanming Li, Santa Clara, CA (US)

(21) Appl. No.: 16/781,523

(22) Filed: Feb. 4, 2020

Related U.S. Application Data
(60) Provisional application No. 62/851,013, filed on May 21, 2019.

(51) Int. Cl. G09G 5/04; G09G 3/34

(52) U.S. Cl. CPC G09G 5/04; G09G 3/3413; G09G 2320/062; G09G 2320/0693; G09G 2320/08; G09G 3/3426

(57) ABSTRACT

An electronic device includes a display having an emulation component and a separate calibration component. The emulation component may provide a user of the device with a list of available emulation presets at least some of which is common across a large batch of displays. The calibration component may include at least one factory calibration setting that may be shared among one or more of the emulation presets. The user may optionally add to the list of emulation presets by filling up empty emulation slots in the emulation component. The user may also be given the option to recalibrate the display or to add custom calibration datasets using calibration targets different than factory targets. The custom calibration datasets may be optimized for one or more of the emulation presets. Thus, when the user selects a particular emulation preset, the display may automatically select the desired calibration dataset for optimal performance.

This application claims the benefit of provisional patent application No. 62/851,013, filed May 21, 2019, which is hereby incorporated by reference herein in its entirety.

### FIELD

This relates generally to electronic devices, and, more particularly, to electronic devices with displays.

### BACKGROUND

Electronic devices may have displays. Displays may be used for displaying visual content for a user. Professional graphics workflows may require various types of displays with different display properties. For instance, one graphics workflow might require a display that is particularly suited for photo-editing, whereas another graphics workflow might require a display that is more suited to outputting video content.

Therefore, a single display that is capable of emulating a wide variety of displays may be desired. It is, however, challenging to build a single display that can perform all the requisite emulation in the display itself while maintaining sufficient accuracy to the advertised specifications associated with each of the emulated displays. Calibrating such type of display that meet all the various emulation requirements adds another level of complexity.

It is within this context that the embodiments herein arise.

### SUMMARY

An electronic device may have a display mounted in a housing. The display may have pixels that display an image. The display may further include an emulation circuit that is configured to receive image content from a display host and that is operable to support multiple emulation pre-setup configurations (or presets) with different display properties. The display may also include a calibration circuit separate from the emulation circuit. The calibration circuit may be configured to store at least one factory calibration dataset that is shared among any number of the emulation presets. The pixels may then display the image content that has been modified by both the emulation circuit and the calibration circuit. The emulation circuit may be further configured to provide display identification and configuration data, which advertises emulated display capabilities to the display host. If desired, the calibration and emulation circuits may be combined into a single circuit that stores the emulation presets and calibration datasets separately.

The emulation presets are generic across different displays, whereas the factory calibration dataset is unique to each display. The emulation presets are visible to the display host, whereas the factory calibration dataset may optionally be hidden from the host. The emulation presets may include a browsing preset, a movie preset, a photo-editing preset, a printing preset, a gaming preset, an outdoors preset, a privacy preset, etc. The emulation presets may include a list of pre-defined emulation settings created initially by the manufacturer and at least one custom emulation setting that is created at a later point in time by a user of the device. If desired, the calibration circuit is further configured to an updated factory calibration dataset using factory targets or custom calibration datasets obtained using calibration targets different than the factory targets.

The display may be further configured to present the user with an opportunity to add to the list of predefined emulation presets, with an opportunity to add additional calibration datasets to the calibration circuit, with an opportunity to switch to a different emulation preset, and with an opportunity to switch to a different calibration dataset. In response to the user selecting a particular emulation preset, the calibration circuit may automatically select an appropriate calibration dataset optimized for that particular emulation preset.

### BRIEF DESCRIPTION OF THE DRAWINGS

FIG. 1 is a diagram of an illustrative electronic device with a display in accordance with an embodiment.

FIG. 2 is a diagram of an illustrative display having separate emulation and calibration circuits in accordance with an embodiment.

FIG. 3 is a diagram illustrating the differences between emulation settings and calibration settings in accordance with an embodiment.

FIG. 4 is a diagram illustrating how emulation settings can be combined with calibration settings to generate the actual output in accordance with an embodiment.

FIG. 5 is a diagram showing how an illustrative display can be provided with multiple emulation slots and calibration slots in accordance with an embodiment.

FIG. 6 is a flow chart of illustrative steps for operating the display shown in FIG. 5 in accordance with an embodiment.

FIG. 7A is a diagram showing how a user-selected predefined emulation preset may be automatically paired with a factory calibration dataset in accordance with an embodiment.

FIG. 7B is a diagram showing how a custom user-created emulation preset may be automatically paired with the factory calibration dataset in accordance with an embodiment.

FIG. 7C is a diagram showing how a user-selected predefined emulation preset may be paired with a user-recalibrated dataset in accordance with an embodiment.

FIG. 7D is a diagram showing how a custom user-created emulation preset may be paired with a user-created calibration dataset in accordance with an embodiment.

FIG. 7E is a diagram showing how a user-selected predefined emulation preset may be paired with a user-created calibration dataset in accordance with an embodiment.

### DETAILED DESCRIPTION

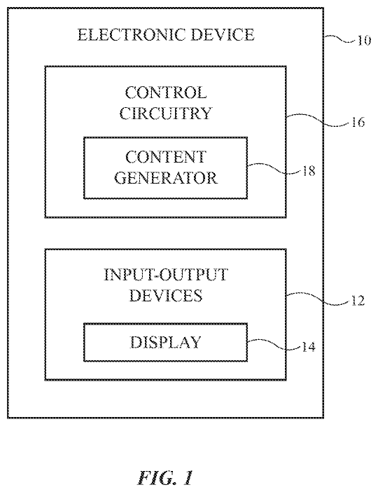

FIG. 1 is a diagram of an illustrative electronic device 10. Device 10 may be a laptop computer, a stand-alone display, an embedded system such as a kiosk or vehicle with a display, a television, a computer with an integrated display, a tablet computer, a cellular telephone, a wrist-watch device, other miniature handheld or wearable equipment, or other electronic equipment that includes a display such as display 14.

As shown in FIG. 1, electronic device 10 may have control circuitry 16. Control circuitry 16 may include storage and processing circuitry for supporting the operation of device 10 (e.g., display driver circuitry, graphics processing circuitry, etc.). The storage and processing circuitry may include storage such as hard disk drive storage, nonvolatile memory (e.g., flash memory or other electrically-programmable-read-only memory configured to form a solid-state drive), volatile memory (e.g., static or dynamic random-access-memory), etc. Processing circuitry in control circuitry 16 may be used to control the operation of device 10 and the operation of a display in device 10. The processing circuitry may be based on one or more microprocessors, microcontrollers, digital signal processors, baseband processors, power management units, audio chips, application specific integrated circuits, etc.

Control circuitry 16 may include a content generator such as content generator 18. Content generator 18 may be associated with an application running on control circuitry 16 such as a game, a media playback application, an application that presents information to a user, an operating system function, or other code running on control circuitry 16 that generates image data to be displayed on display 14.

Input-output circuitry in device 10 such as input-output devices 12 may be used to allow data to be supplied to device 10 and to allow data to be provided from device 10 to external devices. If desired, input-output devices 12 may include buttons, joysticks, scrolling wheels, touch pads, keypads, keyboards, microphones, speakers, tone generators, vibrators, cameras, light-emitting diodes and other status indicators, data ports, etc. A user can control the operation of device 10 by supplying commands through input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements. Display 14 may include an array of display pixels (e.g., tens, hundreds, thousands, tens of thousands, or more display pixels arranged in rows and columns) that are used to display the image data received from content generator 18. The display pixels may be based on organic light-emitting diodes, crystalline semiconductor diodes (e.g., micro-light-emitting diodes), liquid crystal display structures, electrophoretic display structures, plasma display structures, electrowetting display structures, or other suitable display technologies. Since content generator 18 determines what data to send to display 14 at any given point in time, content generator 18 is sometimes referred to as the display “host” device.

Professional graphics workflows often require various display types with different output properties. To satisfy this need, display 14 is configured to emulate a wide variety of displays. When emulating a particular display type, display 14 may identify or advertise itself to the host (e.g., the content generator 18 that is part of control circuitry 16) as having some or all of the emulated display's characteristics and may perform all of the emulation within itself (e.g., without requiring content generator 18 to preemptively modify the image content it generates when changing from one emulation to another) while properly displaying data as the emulated display would by maintaining sufficient accuracy in accordance with its advertised specifications.

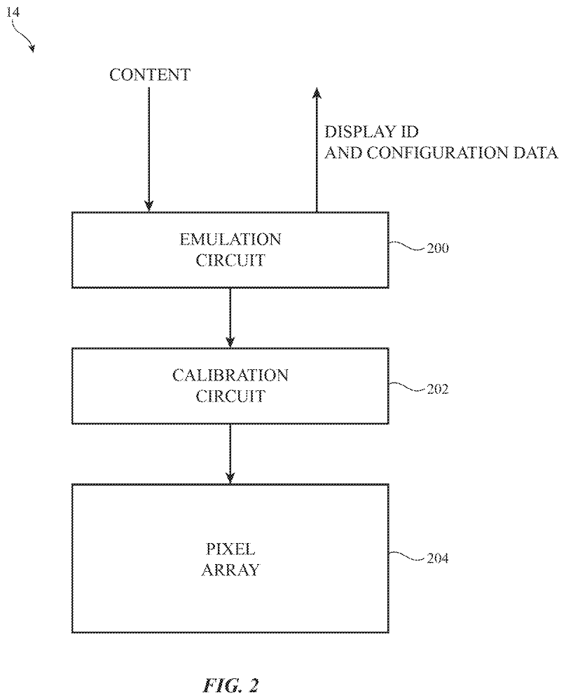

FIG. 2 is a diagram of display 14 that is provided with separate emulation and calibration circuits. As shown in FIG. 2, display 14 may include an emulation block such as emulation circuit 200, a separate calibration block such as calibration circuit 202, and pixel circuitry such as display pixel array 204. Emulation circuit 200 may receive image content (sometimes also referred to as image data) from content generator 18.

Emulation circuit 200 provides display 14 with a number of different emulated display configurations that a user of device 10 can switch among. Emulation circuit 200 may provide a list of at least two different emulation display configurations, at least three different emulation display configurations, at least four different emulation display configurations, at least five different emulation display configurations, two to ten different emulation display configurations, more than ten different emulation display configurations, or any suitable number of emulated display configurations. Depending on which emulated display configuration is currently selected by the user, emulation circuit 200 may provide a set of display identification (ID) and configuration data advertising the properties and capabilities of the selected emulation display configuration back to the host.

Emulation circuit 200 may output emulated display data to calibration circuit 202. Calibration circuit 202 is configured to correct the physical panel performance of display 14 at one or more display calibration targets. Calibration circuit 202 aims to mitigate potential non-uniformities between two different displays 14 that ought to be identical but are actually slightly different in terms of display performance due to manufacturing variations. Calibration circuit 202 may receive and emulated display data and generate corresponding calibrated display data, which can then be display on pixel array 204. Having an emulation block and a separate calibration block in this way provides a tangible technical improvement to computer functionality by enabling the sharing of a limited number of calibration datasets between multiple emulation configurations (e.g., additional emulation presets may be added without the need to recalibrate the display), which can help reduce calibration time significantly. In another suitable arrangement, the emulation settings and the calibration settings (which are stored separately) may be mathematically combined within a single circuit to help save power.

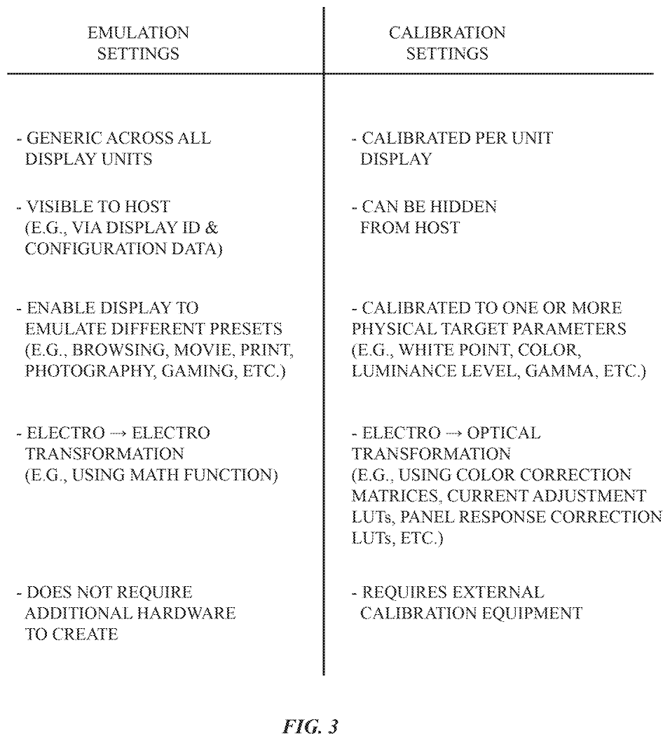

FIG. 3 is a diagram illustrating some differences between emulation settings and calibration settings. The emulation settings—sometimes referred to as emulation “presets” (for pre-set configurations)—are display emulation settings that are generic or common across all displays 14. For example, in a group of a thousand electronic devices 10 each having a display 14, the display 14 in each of the thousand devices 10 may at least initially be provided with the same emulation presets. In contrast, calibration settings—sometimes referred to herein as calibration “datasets”—may vary from one display to another (i.e., each display 14 may have its own unique calibration dataset(s)). This is because each physical display 14 has its own unique panel characteristics and properties, so a different amount of adjustment or calibration is needed between any two disparate display panels to achieve the same display target. Calibration datasets therefore follows the display unit and should persist across power cycles.

Another difference is that the emulation presets are generally visible to the host (e.g., content generator 18 in FIG. 1) and/or the user of device 10, whereas the calibration datasets might be hidden from the host. As described above in connection with FIG. 2, the emulation circuit 200 reveals or advertises its emulation capabilities and associated specifications of each preset by providing display ID and configuration data to the host. In contrast, the display host may be generally unaware of any calibration settings as it merely assumes the display is appropriately calibrated according to some desired target. In yet other suitable configurations, the calibration settings might be exposed to the user to provide more customized calibration options.

Functionally, the emulation settings enable each display 14 to emulate different types of displays (e.g., emulation presets enable a single display to emulate different display targets or display modes). As examples, there may be a first emulation preset configured for normal web browsing, a second emulation preset configured for movie/cinema viewing, a third emulation preset configured for printing, a fourth emulation preset configured for photo editing, a fifth emulation preset configured for gaming, a sixth emulation preset configured for outdoor usage, a seventh emulation preset configured for privacy, etc. These various display emulation modes are merely illustrative. If desired, the emulation circuit may be configured to provide any suitable number of display emulation presets. In contrast, the calibration settings are used to calibrate a particular display 14 to one or more physical targets. Exemplary calibration target parameters include a target white point, a target color space, a target luminance level, a target gamma, etc. The calibration datasets corrects each display panel so that it operates in a known state.

As described above, each emulation preset takes the raw image data and then modifies it so that is emulates the output properties of the selected display type. In other words, it converts the raw image content to an emulated image content using some mathematical function. From another perspective, the emulation data includes mathematical transformation data that adjusts the display performance from the calibrated target to the emulated target. This sort of data conversion may be categorized as an electro-to-electro transformation. The emulation presets are therefore modifications on top of the current calibration state. In contrast, a calibration dataset aims to take whatever data it receives and calibrates that data so that any variations and imperfections associated with that particular display hardware is corrected. The calibration datasets may include color correction matrices, electrical current adjustment lookup tables (LUTs), panel response correction lookup tables, just to name a few.

Moreover, all of the emulation may be performed within the display itself (i.e., emulating the various display types does not require additional hardware to create). In contrast, calibration (whether or not performed at the factory or by the user outside of the factory) generally require dedicated external calibration equipment that can be used to monitor the output of a particular display 14 during calibration operations. The table of FIG. 3 serve to summarize at least some of the key differences between emulation and calibration data and is not intended to be an exhaustive list. In general, the emulation presets and the calibration datasets may be differentiated by additional distinguishing features not listed in FIG. 3. Regardless, emulation data and calibration data take on very different meanings in this context.

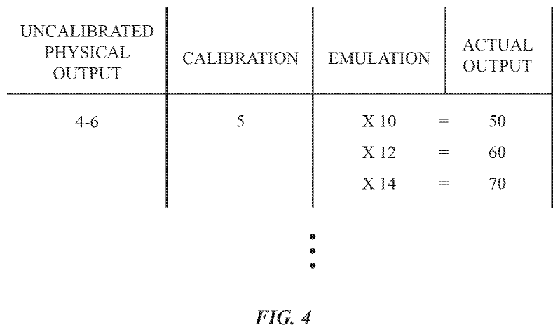

FIG. 4 is a diagram illustrating how emulation settings can be combined with calibration settings to generate the actual display output value. As described above in connection with FIG. 3, the emulation presets include mathematical transformation data that adjusts the display performance from the calibration target to the emulated target. As shown in FIG. 4, assume that the uncalibrated physical display parameter of interest has an output range of approximately 4 to 6. After calibration, the parameter may be calibrated to output the intended target value of 5. The emulation presets may then transform the calibrated output using some mathematical function. In the example of FIG. 4, a first emulation setting scales the calibrated output by a factor of 10, a second emulation setting scales the calibrated output by a factor of 12, and a third emulation setting scales the calibrated output by a factor of 14.

Operated in this way, the actual display output may be equal to 50 (i.e., 5*10) during the first emulated state, may be equal to 60 (i.e., 5*12) during the second emulated state, and may be equal to 70 (i.e., 5*14) during the third emulated state. The example emulation method of FIG. 4 is merely illustrative and is not intended to limit the scope of the present embodiments. In general, the emulation presets may represent any suitable mathematical or algorithmic transformation that is separate and distinct from the calibration datasets.

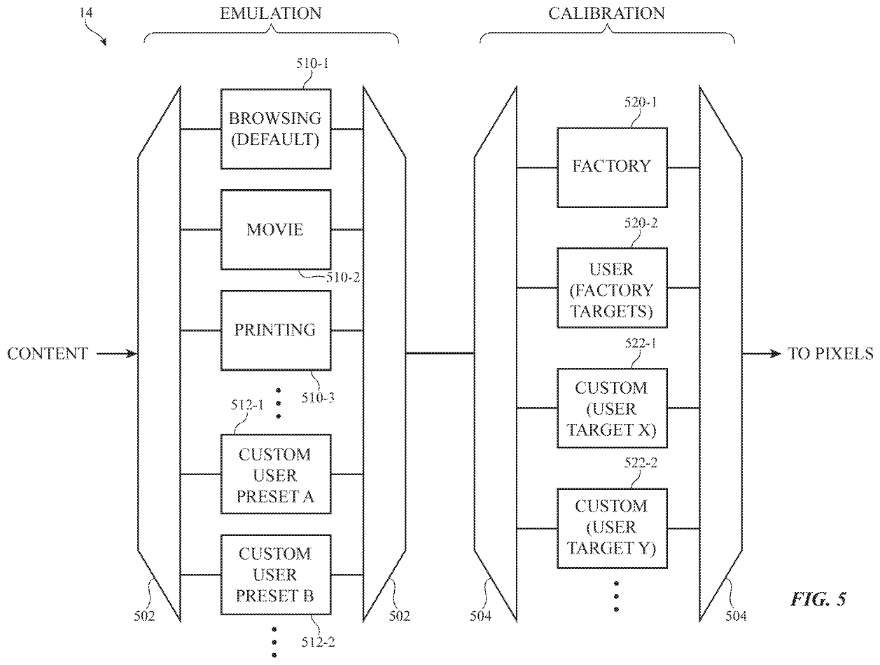

FIG. 5 is a diagram showing how display 14 can be provided with multiple emulation slots and calibration slots. As shown in FIG. 5, display 14 may include emulation switching circuitry 502 configured to support switching among a group of available emulation slots and calibration switching circuitry 594 configured to support switching among a separate group of available calibration slots. A web browsing display emulation preset 510-1 (which may represent a default viewing mode) may occupy a first emulation slot. A movie or cinema display emulation preset 510-2 may occupy a second emulation slot. A printing emulation preset 510-3 may occupy a third emulating slot. In general, display 14 may be initially provided with any suitable number of pre-defined emulation presets (e.g., display 14 may be shipped to customers with one or more “built-in” emulation settings to cover important graphics workflows). The manufacturer may optionally add to this list of pre-defined emulation presets even after device 10 has shipped (e.g., by uploading new emulation settings into display 14 via a firmware or software update) without requiring display 14 to be recalibrated.

The user of display 14 will also be able to add custom emulation presets to any available empty emulation slots. In the example of FIG. 5, a first custom user preset A (512-1) may occupy another emulation slot, whereas a second custom user preset B (512-2) may occupy yet another emulation slot. In general, display 14 may be provided with any suitable number of total available emulations slots (e.g., 10 or more emulation slots, 10-20 emulation slots, more than 20 emulation slots) to accommodate any number of pre-defined emulation presets (e.g., an initial list of presets prepared by the manufacturer of device 10) or any desired number of custom user emulation presets.

Display 14 may ship with at least one factory calibration dataset 520-1 that occupies a first calibration slot. Alternatively, display 14 might be shipped without any calibration data, which may then be optionally calibrated by the user. The user may optionally recalibrate the display as the display ages to maintain its performance using factory targets to obtain an updated factory calibration dataset 520-2, which can occupy a second calibration slot. The updated factory calibration dataset 520-2, which is typically obtained at a later point time in time compared to when the factory calibration dataset 520-1 was created, represents a more up-to-date diagnosis of the display panel and may therefore override the initial factory calibration dataset 520-1.

If desired, the user can also add one or more custom calibration datasets using calibration targets that are different than the factory target (e.g., the user may perform their own calibrations and re-link one or more existing emulation presets to the new calibration settings). For example, the user may add a first custom calibration dataset 522-1 (e.g., using calibration target X that is different from the factory targets), which occupy another calibration slot. The user may also add a second custom calibration dataset 522-2 (e.g., using calibration target Y that is different than the factory targets and target X). Custom user calibration dataset(s) created in this way should be stored alongside the factory calibration dataset but should not replace it. If desired, the custom user calibration dataset(s) could also replace the factory calibration dataset.

Each custom calibration dataset may be configured for a specific emulation preset or may serve to augment the existing calibration datasets. In general, display 14 may be provided with any suitable number of total available calibration dataset slots (e.g., two or more calibration slots, 3 to 10 calibration slots, more than 10 calibration slots) to accommodate any number of factory calibration datasets or any desired number of custom user calibration datasets. At one extreme, each emulation preset may be provided with its own calibration dataset optimized for that emulated display target (e.g., there may be a one-to-one mapping between the emulation presets and the calibration datasets). At the other extreme, a single calibration (e.g., any one of the calibration datasets) can be used for multiple emulation presets. Any degree of intermediate pairing where different groups of emulation presets are linked to different calibration datasets may be implemented. Due to the time consuming nature of a calibration procedure, a minimum number of calibration operations should be performed and stored within the available calibration slots.

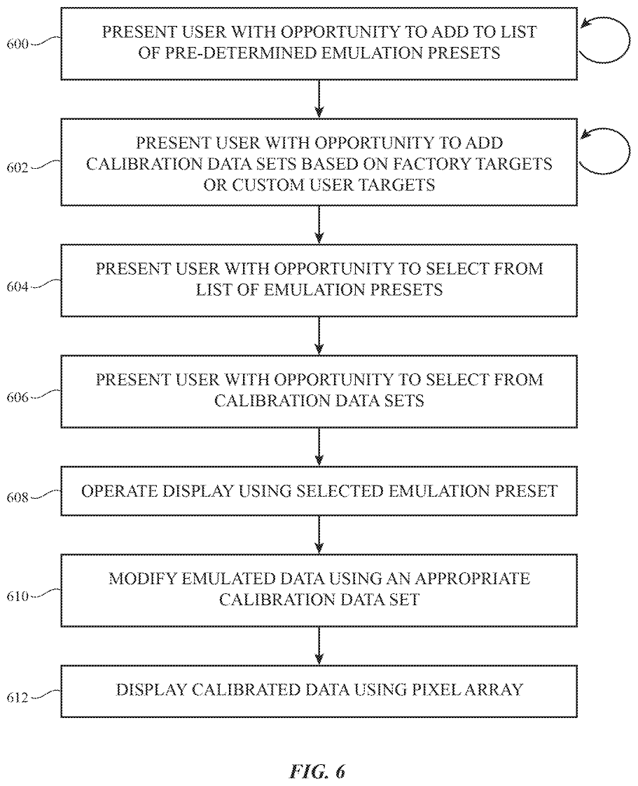

FIG. 6 is a flow chart of illustrative steps for operating display 14 of the type described in connection with at least FIGS. 1-5. At step 600, device 10 may present a user with an opportunity to add to the list of pre-defined emulation presets. The user may decide to augment the list of emulation presets by filling in any one or more of available emulation slots during the lifetime of the display.

At step 602, device 10 may present the user with an opportunity to add a calibration dataset based on factory targets or custom user targets. In other words, the user may decide to build upon the factory calibration dataset by filling in any one or more of the available calibration slots during the lifetime of the display.

At step 604, device 10 may present the user with an opportunity to select from the list of emulation presets (or display emulation settings). If the user does not proactively make a particular selection, the default emulation preset may be used. The user may select from any one of the pre-defined emulation presets provided by the manufacturer or from any one of the user-created custom emulation presets depending on the desired graphics workflow suitable for the current usage scenario.

At step 606, device 10 may optionally present the user with an opportunity to select from the list of calibration datasets (or display calibration settings). If the user does not proactively make a particular selection, the factory calibration dataset may be used. The user may select from any one of the factory-based calibration settings (see, e.g., calibration datasets 520-1 and 520-2 in FIG. 5) or from any one of the user-created custom calibration settings (see, e.g., calibration datasets 522-1 and 522-2 in FIG. 5).

At step 608, display 14 may be operated using the emulation preset selected during step 604. At step 610, the calibration circuit within display 14 (e.g., calibration block 202 of FIG. 2) may modify the emulated data produced from the emulation circuit (e.g., emulation block 200 of FIG. 2) using an appropriate calibration dataset determined during step 606. At step 612, display 14 may feed the calibrated data to the display pixel array for final output.

Although the methods of operations are described in a specific order, it should be understood that other operations may be performed in between described operations, described operations may be adjusted so that they occur at slightly different times or described operations may be distributed in a system which allows occurrence of the processing operations at various intervals associated with the processing, as long as the processing of the overlay operations are performed in a desired way.

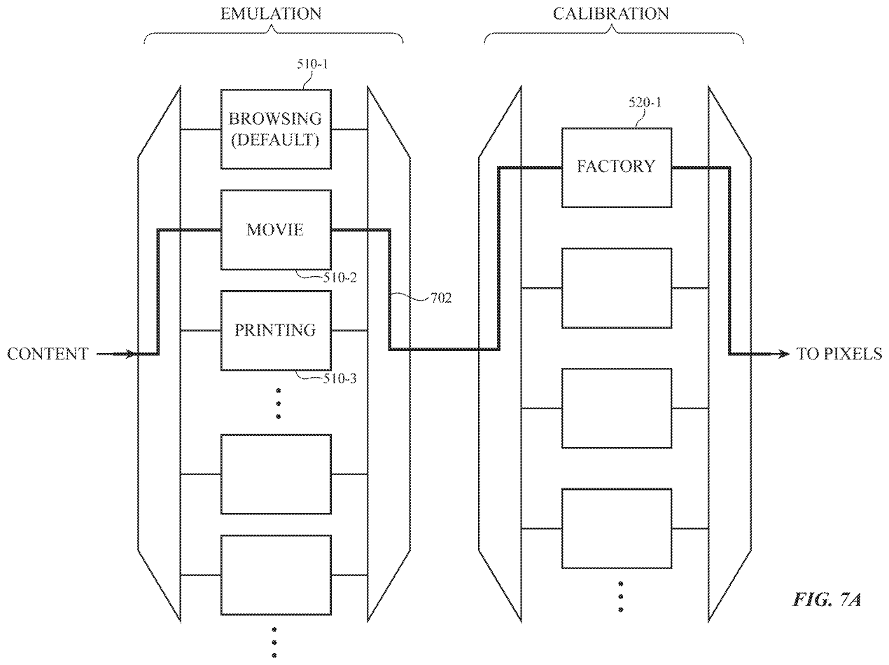

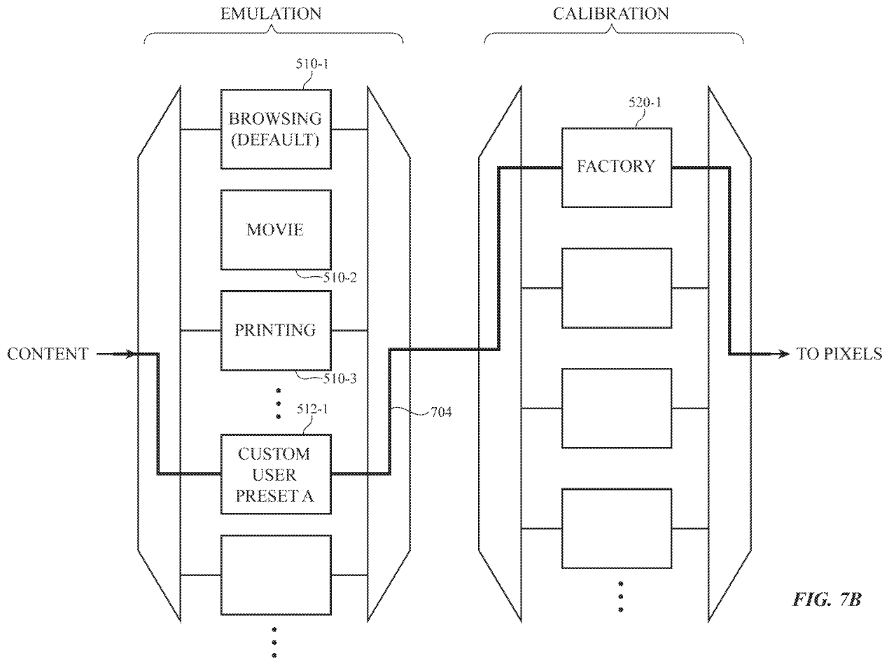

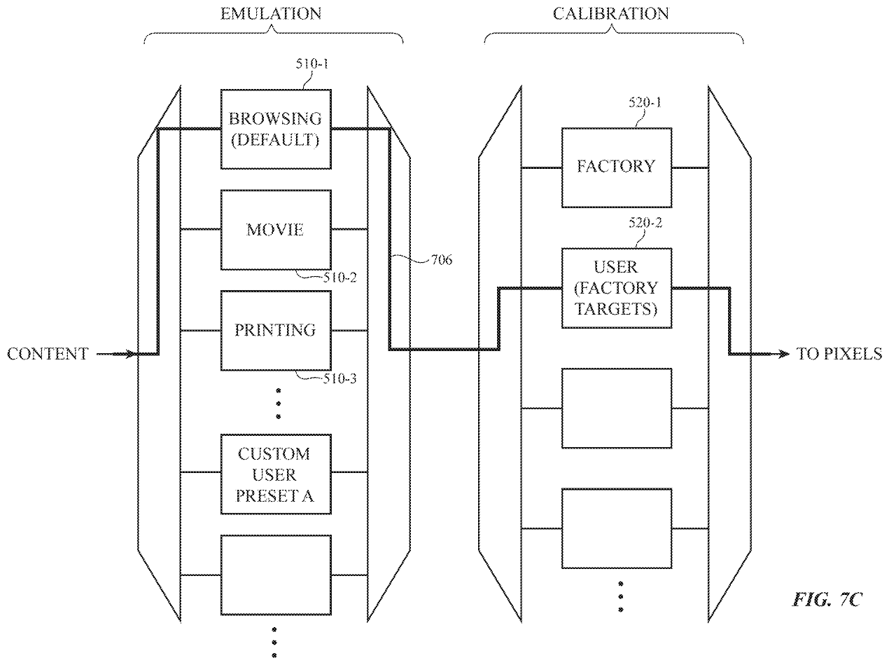

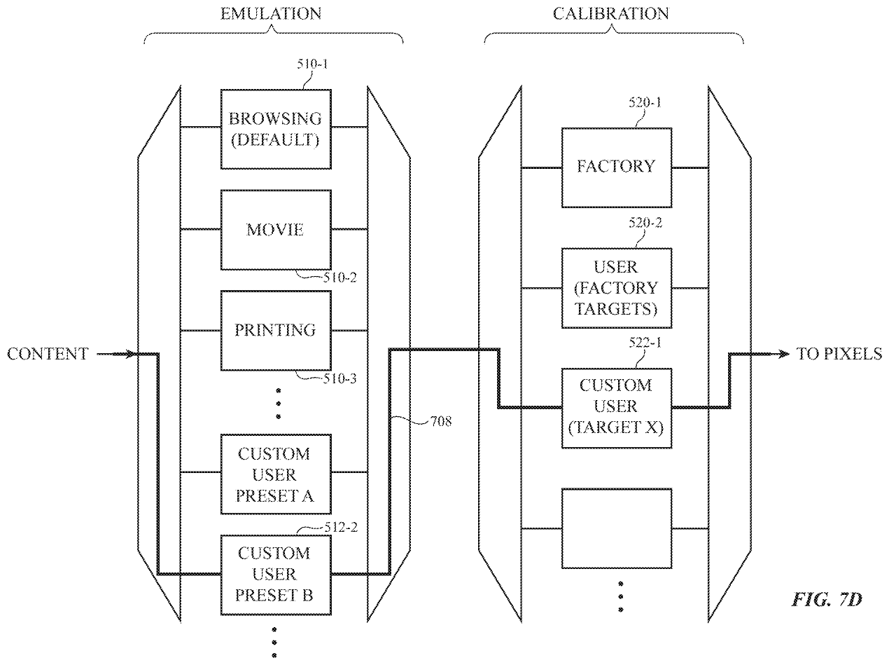

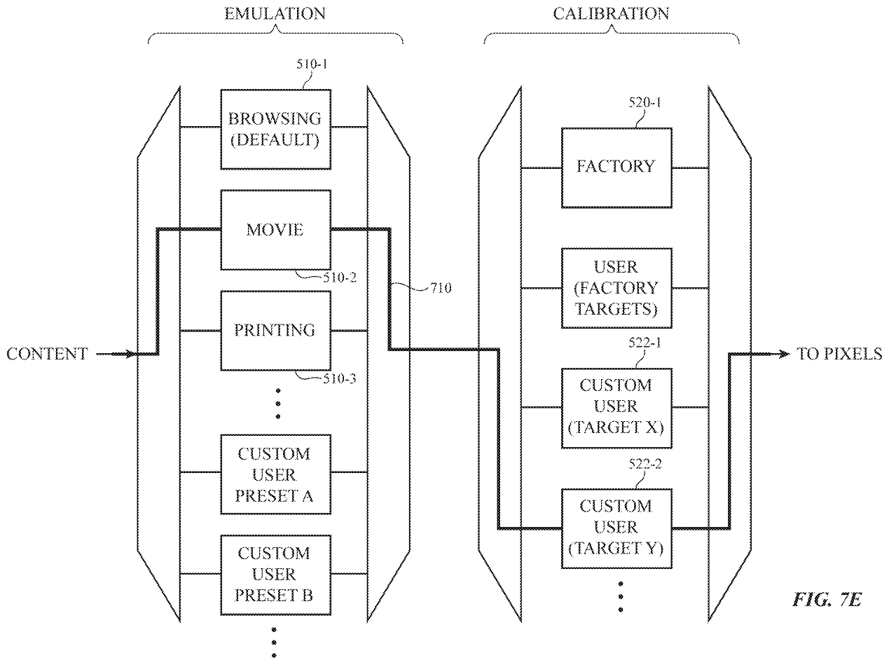

FIG. 7A illustrates an example where a user-selected predefined emulation preset is automatically paired with a factory calibration dataset. As shown in FIG. 7A, the movie emulation preset 510-2 is selected by the user. Since the factory calibration dataset 520-1 is the only calibration setting currently available, that setting will be automatically selected, as shown by path 702. If the user were to select another one of the available emulation presets, the factory calibration dataset 520-1 will also be used since there are currently no other available calibration settings. This example therefore illustrates the scenario where all display emulation presets share a common factory calibration dataset.

FIG. 7B illustrates an example where a custom user-created emulation preset may be automatically paired with the factory calibration dataset. As shown in FIG. 7B, the custom user emulation preset 512-1 is created and selected for use. Once again, since the factory calibration dataset 520-1 is the only calibration setting currently available, that setting will be automatically selected, as shown by path 704. If desired, the customization range for emulation may be limited to ensure sufficient front-of-screen accuracy given the fixed factory calibration setting 520-1.

FIG. 7C illustrates another example where the user re-calibrates display 14 (e.g., using some manufacturer-approved calibration software and external hardware) according to factory targets. Recalibration in the field might be useful to correct the white point, color space, luminance, and other display properties as the display ages over time. The new user-created updated factory calibration dataset 520-2 may be used instead of the manufacture-provided factory calibration dataset 520-1, as shown by path 706. The original factory calibration dataset 520-1 is always retained within device 10 and can be optionally reverted to at any point in time.

FIG. 7D illustrates another scenario where the user creates a custom emulation setting such as emulation preset 512-2 that require a custom calibration dataset 522-1 to achieve an acceptable front-of-screen performance, as shown by path 708. Thus, when user selects emulation preset 512-2 for operation, display 14 will automatically determine that custom calibration dataset 522-1 needs to be selected since it knows that calibration dataset 522-1 is optimized for that particular emulation mode. If, however, the user were to select any of the other emulation presets, display 14 may revert back to either calibration setting 520-1 or 520-2 (assuming calibration dataset 522-1 is not optimized for any of the other emulation modes).

FIG. 7E illustrates yet another scenario wherein the user creates a custom calibration dataset 522-2 that is particular suited for the movie emulation preset 510-2. Thus, when user selects emulation preset 510-2 for operation, display 14 will automatically determine that custom calibration dataset 522-2 needs to be selected since it knows that calibration dataset 522-2 is optimized for at least that particular emulation state. It is possible that custom calibration setting 522-2 might also be optimized for one or more other emulation presets. The desired mapping or linking of the emulation presets to appropriate calibration datasets may all be handled internally within display 14.

The foregoing is merely illustrative and various modifications can be made to the described embodiments. The foregoing embodiments may be implemented individually or in any combination.

What is claimed is:

1. A display, comprising:
an array of pixels;
an emulation circuit configured to receive image content from a display host, wherein the emulation circuit is operable to support a plurality of emulation presets with different display properties; and
a calibration circuit separate from the emulation circuit, wherein the calibration circuit is configured to store at least a factory calibration dataset that is shared among at least two emulation presets in the plurality of emulation presets, and wherein the array of pixels is configured to display the image content that has been modified by the emulation circuit and the calibration circuit.

2. The display of claim 1, wherein the emulation circuit is further configured to provide display identification and configuration data to the display host.

3. The display of claim 2, wherein the display identification and configuration data advertises emulated display capabilities to the display host.

4. The display of claim 1, wherein the display represents one display in a group of displays, wherein the plurality of emulation presets is generic across different displays in the group of displays, and wherein the factory calibration dataset applies to only the display in the group of displays.

5. The display of claim 1, wherein the plurality of emulation presets is visible to the display host, and wherein the factory calibration dataset is hidden from the display host.

6. The display of claim 1, wherein the plurality of emulation presets includes display emulation modes selected from the group consisting of: a browsing preset, a movie preset, a photo-editing preset, and a gaming preset.

7. The display of claim 1, wherein the factory calibration dataset calibrates the display to a target display parameter selected from the group consisting of: a target white point, a target color space, a target luminance level, and a target gamma level.

8. The display of claim 1, wherein the plurality of emulation presets comprises a list of pre-defined emulation settings stored on the display at a first point in time and at least one custom emulation setting that is created at a later point in time.

9. The display of claim 1, wherein the factory calibration dataset is obtained using factory targets, and wherein the calibration circuit is further configured to store an updated factory calibration dataset using the factory targets without deleting the factory calibration dataset.

10. The display of claim 1, wherein the factory calibration data is obtained using factory targets, and wherein the calibration circuit is further configured to store at least one custom calibration dataset obtained using calibration targets different than the factory targets.

11. A method of operating a display, the method comprising:
with an emulation circuit in the display, receiving image content from a content generator and modifying the image content in accordance with an emulation preset selected from among a plurality of emulation presets;
with a calibration circuit separate from the emulation circuit in the display, modifying the image content in accordance with a calibration dataset stored in the display; and
using an array of pixels in the display to output the image content that has been modified by both the emulation circuit and the calibration circuit.

12. The method of claim 11, wherein the plurality of emulation presets comprises a list of predefined emulation presets, the method further comprising:
presenting a user with an opportunity to add to the list of predefined emulation presets.

13. The method of claim 12, further comprising:
presenting the user with an opportunity to add additional calibration datasets to the calibration circuit.

14. The method of claim 13, further comprising:
presenting the user with an opportunity to switch to a different emulation preset.

15. The method of claim 13, further comprising;
presenting the user with an opportunity to switch to a different calibration dataset.

16. The method of claim 14, further comprising:
in response to the user selecting a particular emulation preset, using the calibration circuit to automatically select an appropriate calibration dataset optimized for that particular emulation preset.

17. An electronic device, comprising:
control circuitry configured to generate image content; and
a display configured to receive the image content from the control circuitry, wherein the display includes a plurality of emulation slots configured to receive and store different emulation settings and includes a plurality of calibration slots configured to receive and store different calibration settings.

18. The electronic device of claim 17, wherein the different emulation settings comprise predefined emulation presets and custom emulation presets created by a user of the electronic device.

19. The electronic device of claim 17, wherein the different calibration settings comprise a factory calibration setting and a custom calibration setting created by a user of the electronic device.

20. The electronic device of claim 17, wherein the display is further configured to link each of the different emulation settings to an appropriate calibration setting to optimize for display performance.
